(19) United States
(12) Patent Application Publication
(10) Pub. No.: US 2009/0044283 A1
(43) Pub. Date: Feb. 12, 2009

(54) DOCUMENT MANAGEMENT APPARATUS, DOCUMENT MANAGEMENT SYSTEM AND METHOD, AND COMPUTER-READABLE MEDIUM

(75) Inventor: Taro Yoshihama, Kanagawa (JP)

Correspondence Address: GAUTHIER & CONNORS, LLP, 225 FRANKLIN STREET, SUITE 2300, BOSTON, MA, 02110, US

(73) Assignee: Fuji Xerox Co., Ltd., Tokyo (JP)

(21) Appl. No.: 12/055,530

(22) Filed: Mar. 26, 2008

(30) Foreign Application Priority Data
Aug. 7, 2007 (JP) 2007204891

(51) Int. Cl. H04L 9/32; G06F 21/00

(52) U.S. Cl. 726/28

(57) ABSTRACT

There is provided a apparatus including a unit that, when receiving a second document derived from a first document, registers a derivation relationship indicating that a parent of the second document is the first document; a unit that, when receiving a branching instruction in association with the second document, generates a new group and registers information indicating that the second document belongs to the new group and that, when receiving no branching instruction in association with the second document, registers information indicating that the second and the first document belong to the same group; a unit that registers an access right in association with the group; and a unit that, when receiving a request for an operation of a document from a user, based on an access right corresponding a group to which the document belongs, controls whether to allow the user to perform the operation of the document.

### CROSS-REFERENCE TO RELATED APPLICATIONS

This application is based on and claims priority under 35 USC 119 from Japanese Patent Application No. 2007-204891, filed on Aug. 7, 2007.

### BACKGROUND

1. Technical Field

The present invention relates to a document management apparatus, a document management system and method, and a computer-readable medium.

2. Related Art

There have been proposed systems for tracing the course of distribution of a document in order to recognize the usage state of the document and prevent leakage concerning the document. With these systems, identification information (ID) that has been embedded in a document is recorded at the time of using the document, enabling recognition of the distribution course of the document.

### SUMMARY

According to a first aspect of the invention, there is provided a document management apparatus including a derivation relationship registration unit that, when receiving a second document obtained as a result of an operation performed with respect to a first document, registers in a storage device a derivation relationship indicating that a parent of the second document is the first document; a group information registration unit that, when receiving a branching instruction in association with the second document, generates a new document group and registers in the storage device information indicating that the second document belongs to the new document group and that, when receiving no branching instruction in association with the second document, registers in the storage device information indicating that the second document and the first document belong to a same document group; an access right registration unit that receives input of access right information with respect to a document group and registers the input access right information in the storage device in association with the document group; and a control unit that, when receiving from a user a request for an operation with respect to a document, acquires from the storage device access right information corresponding to a document group to which the document belongs and, by reference to the access right information that is acquired, controls whether or not to allow the user to perform the operation with respect to the document.

### BRIEF DESCRIPTION OF THE DRAWINGS

Exemplary embodiments of the present invention will be described in detail by reference to the following figures, wherein:

FIG. 1 a block diagram schematically showing an example structure of a document management system;

FIG. 2 is a block diagram showing an example internal structure of a client terminal;

FIG. 3 is a view schematically showing an example data structure of an ID-added document;

FIG. 4 is a block diagram showing an example internal structure of a document management server;

FIG. 5 is a view showing example data content of a derivation relationship DB;

FIG. 6 is a schematic view showing a tree structure formed by management IDs in the data content shown in FIG. 5;

FIG. 7 is a view showing an example display screen displaying icons of an ID-added document;

FIG. 8 is a view showing an example of group branching;

FIG. 9 is a block diagram showing an example internal structure of a client terminal including an access control function;

FIG. 10 is a block diagram showing an example internal structure of a document management server including an access control function;

FIG. 11 is a view showing example data content of a derivation relationship DB including an item of a document group;

FIG. 12 is a view showing example data content of an access right DB;

FIG. 13 is a flowchart showing an example processing procedure of a document management server when an ID-added document is acquired;

FIG. 14 is a flowchart showing an example processing procedure of a document management server when an access to an ID-added document is requested;

FIG. 15 is a display example of a display screen showing derivation relationships; and

FIG. 16 is a view showing an example hardware structure of a computer.

### DETAILED DESCRIPTION

An exemplary embodiment of the present invention will be described in detail with reference to the accompanying drawings.

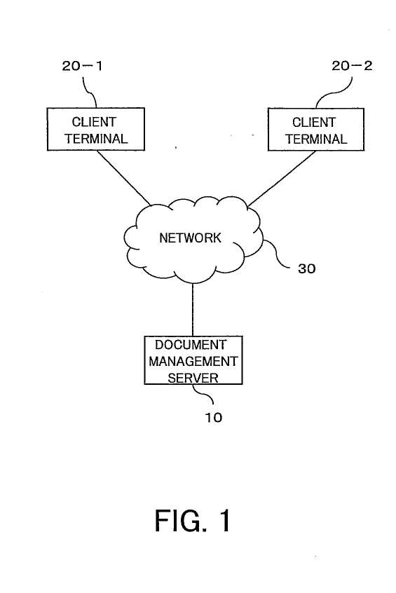

FIG. 1 is a block diagram schematically showing a structure of a document management system. This system is formed of a document management server 10 and client terminals 20-1, 20-2, . . . (hereinafter collectively referred to a client terminal 20) that are connected to one another via a network 30 such as the Internet, a local area network (LAN), or the like.

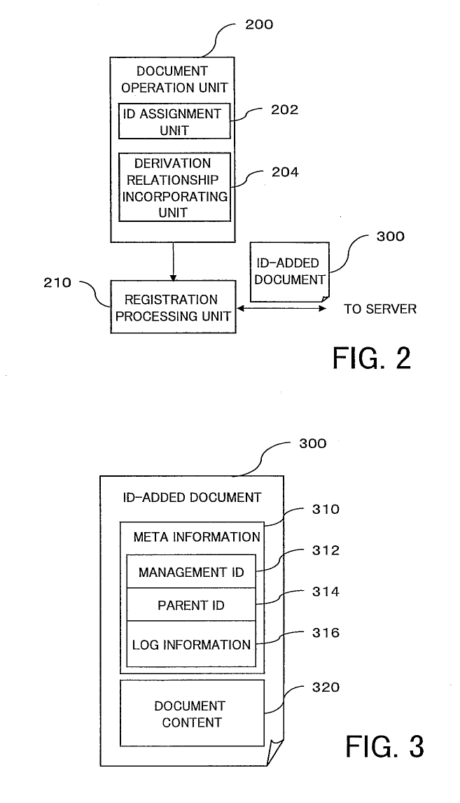

The client terminal 20 will be described with reference to FIG. 2. The client terminal 20 is a terminal used by a user for performing operations on a document, and may be a personal computer, a digital multifunction device (i.e. an image-forming apparatus having a copy function, a print function, and a facsimile function), or the like. As shown in FIG. 2, the client terminal 20 includes a document operation unit 200 and a registration processing unit 210.

The document operation unit 200 is used for performing an operation with respect to a document, including displaying (i.e. “viewing” by a user), editing, printing, and outputting of a document, reading and copying of a paper document, and the like. Although only a single document operation unit 200 is shown in FIG. 2, the individual operations may be performed by different operation units (e.g. different applications such as an editing application and a reading control application). If the document operation unit 200 is software used for creating and editing an electronic document, such as a word processor, for example, the document operation unit 200, in accordance with a user's instruction, displays an electronic document or edits the electronic document. When an operation is performed with respect to a document, the document operation unit 200 outputs an ID-added document 300 that represents a result of the operation.

As shown in FIG. 3, the ID-added document 300 is an electronic document including meta information 310 and document content 320. The document content 320 corresponds to content data of a document that are generated as a result of the operation performed by the document operation unit 200. If the document operation unit 200 is software that creates and edits an electronic document, the document content 320 is a document file generated as a result of editing performed by the software. Alternatively, if the document operation unit 200 is a device that prints an electronic document, the document content 320 may be content data of an electronic document to be printed. Further, if the document operation unit 200 is a device that scans a paper document or a device that copies a paper document, the document content 320 may be image data obtained by reading the paper document.

The meta information 310 is information used for document management, and includes a management ID 312, a parent ID 314, and log information 316.

The management ID 312 is unique identification information of an ID-added document 300 itself. The parent ID 314 is a management ID of a parent ID-added document of that ID-added document 300. Specifically, in this exemplary embodiment, a certain ID-added document and a new ID-added document obtained by performing an operation with respect to the certain ID-added document are treated as having a parent-child relationship. More specifically, when a second ID-added document is obtained by operating a first ID-added document, the first ID-added document is a parent of the second ID-added document, and the second ID-added document is a child of the first ID-added document. For example, when the document operation unit 200 performs an operation with respect to an ID-added document having a management ID “A” and a new ID-added document having a management ID “B” is obtained as a result of the operation, the management ID 312 in the meta information 310 of the latter document is “B” and the parent ID 314 of this document is “A”. Such a parent-child relationship will be referred to a “derivation relationship (of management IDs).”

Here, in a case where an operation of initially registering an electronic document which has not been registered in the present system is performed and also in a case where an operation of scanning or copying an unregistered paper document is performed (in the latter case, an ID-added document including an image obtained by reading the paper document as its document content is generated and registered in the present system), the ID-added document 300 which is generated would have no parent ID 314 (that is, no parent exists).

The log information 316 refers to information of various log items concerning the operation performed when an ID-added document is generated. The log items may include the time and date when the operation was performed, the type of the operation, a user (operator) who instructed the operation, and the like, and are not limited to these examples. The operation types include, for example, registration (i.e. registration of a new document in the present system), viewing, editing, update (registration of an updated version), printing, scanning, copying of a paper document, and the like. For example, when a user uses the document operation unit 200 to edit a first ID-added document and then instructs completion of editing, the log information 316 of the resulting second ID-added document may include the time of editing completion, identification information of a user who instructed the editing, and the type of operation “editing.”

Here, the operation types included in the log information 316 are operation types corresponding to the classification intended for recording logs and need not correspond to the operation types actually executed by the document operation unit 200. In this regard, multiple operation types executed by the document operation unit 200 may be associated with a single operation type intended for log recording. For example, in both the case where an ID-added electronic document is edited in a document editing application and “registration as an updated version” is instructed on an operation menu and the case where a paper document with a management ID is read and “registration of a read document as an approved version” is instructed on the operation menu of the reading control application, the same value of the operation type “updating” is to be included in the log information 316.

A specific example of the meta information 310 generated by the document operation unit 200 is as follows.

### EXAMPLE 1

<metadata sid=“A” date=“2006-10-01T10:00” method=“register” filename=“aaa.doc” user=“user1” />

Here, the “sid” attribute corresponds to a management ID, the “date” attribute corresponds to operation time and date, and the “method” attribute corresponds to an operation type. Further, the “filename” attribute is a file name of the target ID-added document and the “user” attribute corresponds to user identification information of a user who instructed the operation. The method attribute value “register” in Example 1 represents a name of an operation type indicative of a registration operation of a new document (which has not been registered in the document management server 10). Because the target operation is registration of a new document, a “pid” attribute indicating a parent ID is omitted. However, the meta information may include the attribute such as pid=“null” for explicitly indicating that no parent ID exists.

Here, the document operation unit 200 may encrypt a document which is obtained by an operation, in such a manner that a document operation unit 200 which conforms to the present system would be able to decrypt the encrypted document. In this case, the document content 320 of the ID-added document 300 output from the document operation unit 200, which has been encrypted, can be decrypted only by the document operation unit 200 conforming to the present system. Accordingly, when such an ID-added document is operated, in which case the document operation unit 200 is used, the operation is detected by the document operation unit 200 and the content of the operation is reported from the document operation unit 200 to the document management server 10. Further, in addition to the document content 320, the meta information 310 (or a portion of the meta information) may also be encrypted.

Referring back to FIG. 2, the document operation unit 200 includes an ID assignment unit 202 and a derivation relationship incorporating unit 204 so as to generate the ID-added document 300 described above as a result of an operation. The ID assignment unit 202 assigns a unique management ID to an ID-added document generated as a result of an operation. The management ID needs to be identification information that is unique at least within the present system. For example, it is possible to obtain a hash value of an ID-added document 300 (excluding the management ID 312) to be generated as a result of an operation and use the hash value as a management ID of the ID-added document 300. When a collision-resistant cryptographic hash function, such as SHA-256 (which is a cryptographic hash function having a hash value of 256 bits defined in FIPS (Federal Information Processing Standards) 180-2 by NIST (National Institute of Standards and Technology)) is used as the hash function, a management ID having practically sufficient uniqueness can be generated. As a matter of course, a method of generating a management ID which is unique within the system by each client terminal 20 is not limited to the above example. When the management ID includes identification information that is specific to each client terminal 20, the management ID that is unique within the system can be generated in each client terminal 20.

The derivation relationship incorporating unit 204 generates meta information 310 including a new management ID 312 assigned to a document acquired by a result of an operation by the ID assignment unit 202, a parent ID 314 that is a management ID of a parent document with respect to which the operation has been performed (in the case of initial registration, no such parent ID exists), and log information 316 concerning the operation. Here, the derivation relationship incorporating unit 204 holds information concerning a correspondence relationship indicating a correspondence between the individual operation types actually executed by the document operation unit 200 and the individual operation types intended for log recording, and, using such information, acquires a value of the operation type to be included in the log information. The derivation relationship incorporating unit 204 then adds the meta information 310 to the document content of the operation result to thereby generate and output an ID-added document 300 acquired after the operation.

When the document operation unit 200 is application software, the ID assignment unit 202 and the derivation relationship incorporating unit 204 may be implemented as a plug-in program that is added to the software.

The registration processing unit 210 performs processing for registering to the document management server 10 the ID-added document 300 output from the document operation unit 200. Thus, each client terminal 20 registers the ID-added document 300 obtained as a result of an operation performed by each client terminal 20 itself to the document management server 10 as described above, so that the document management server 10 can recognize the derivation relationships between the respective ID-added documents 300.

Similar to general document files, the ID-added document 300 output from the document operation unit 200 as a result of an operation can be sent to other users by electronically copying or by attaching the same to an electronic mail and the like. Here, because, in this example, software for use in transmission of an electronic mail does not comply with the present system, this transmission operation is not reflected in an ID-added document and therefore is not recorded in the document management server 10. When a user who receives an ID-added document 300 from another user uses the document operation unit 200 of his or her own client terminal 20 to perform an operation with regard to the received ID-added document 300, a new ID-added document to which a new management ID is assigned in accordance with the operation is to be generated.

Further, when printing an electronic document with the document operation unit 200, the document operation unit 200 may generate a management ID and embed the management ID in the printed electronic document. Here, embedding of the management ID can be performed, for example, by superposing a code image representing the management ID with a printed image of the electronic document. Further, when a print sheet includes an RFID (Radio Frequency Identifier) tag, the management ID may be written in the RFID tag. When a printing operation is performed as described above, the document operation unit 200 registers in the document management server 10 an ID-added document including meta information such as the management ID, the operation type, which is “printing” in this case, and the like. Further, when an ID-added document is printed, a new ID-added document including the management ID of the ID-added document as a parent ID 314 is generated. The new ID-added document corresponding to such a printing operation may include, as the document content 320, printing data such as page description language data, and bit map image data representing a printed image or a document file which is printed.

Further, when a paper document having a management ID embedded therein is read by the document operation unit 200, the document operation unit 200 assigns a new management ID with respect to the reading operation, and generates an ID-added document including an image of the reading result as the document content 320 and registers the ID-added document in the document management server 10. The management ID read from the original paper document is set as a parent ID 314 of the ID-added document. At the time of copying a paper document having a management ID embedded therein, both the reading processing and the printing processing described above are to be performed.

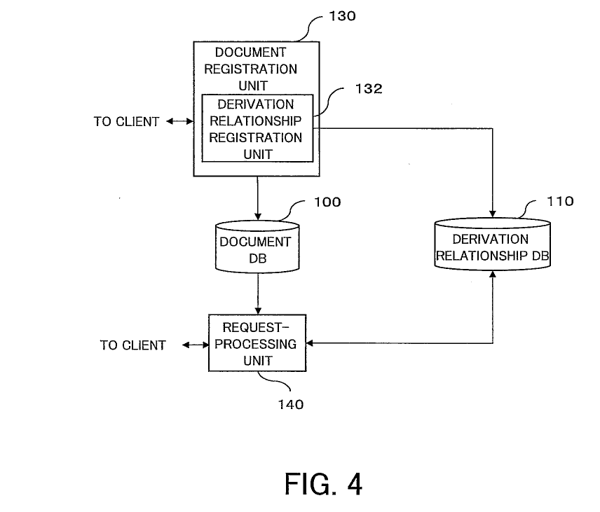

Next, an example of the document management server 10 will be described. The document management server 10 stores ID-added documents 300 sent from multiple client terminals 20 in the system and provides various services to users in accordance with the stored information. As shown in FIG. 4, the document management server 10 includes a document DB 100, a derivation relationship DB 110, a document registration unit 130, and a request-processing unit 140.

The document DB 100 is a database that stores document content 320 of an ID-added document 300 transmitted from the client terminal 20. Each document content 320 stored in the document DB 100 may be managed by reference to a unique content ID. Although a hash value obtained by a cryptographic hash function of the corresponding document content may be used as the content ID, the content ID is not limited to this example. The content ID may be assigned by the client terminal 20, in which case the content ID may be included in the meta information 310. Alternatively, in place of assignment of the content ID, the document content 320 may be stored in the document DB 100 in association with a management ID of the ID-added document 300 corresponding to that document content.

The document registration unit 130 registers the document content and the meta information of an ID-added document received from the client terminal 20 in the document DB 100 and the derivation relationship DB 110, respectively. Registration of the meta information, among the above information, is managed by a derivation relationship registration unit 132.

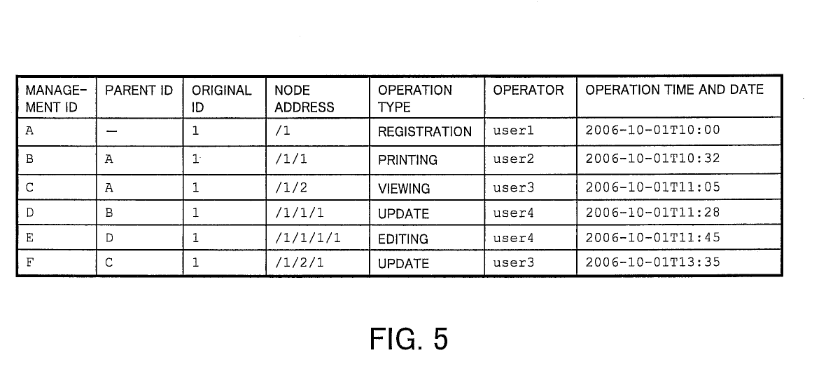

The derivation relationship DB 110 is a database that stores meta information mainly concerning the information of a derivation relationship in such an ID-added document 300. FIG. 5 shows example data content of the derivation relationship DB 110. The information in one row in the table shown in FIG. 5 represents a meta information record corresponding to one ID-added document 300. In this example, items including a parent ID, an original ID, a node address, an operation type, an operator, and an operation time and date are registered in correspondence to the management ID of each ID-added document 300. The information items in the meta information record are not limited to the above example, and any items necessary for the purpose of management can be recorded, so long as the pair consisting of the management ID and the parent ID is included. Here, the items of the operation type, the operator, and the operation time and date are as described above.

The original ID is identification information that specifies a document corresponding to a root of a tree in the derivation relationship. When a new document to which no management ID has been assigned is registered in the present system, the present system assigns a unique original ID to the new document. Then, data of the new document (e.g., a document file or an image file obtained as a result of scanning) are registered in the document management server 10 in association with the original ID, and an ID-added document including the content of the document is provided to a user who performed the registration. Thereafter, a descendent ID-added document derived from this ID-added document is to be associated with the original ID. It can be recognized that ID-added documents having the same value of the original ID are derived from the same document corresponding to a root. In the example shown in FIG. 5, all the ID-added documents that are listed are derived from a single document having the original ID “1”.

The node address indicates a position of a node corresponding to a target management ID (a target ID-added document) in a tree formed by derivation relationships among ID-added documents. In description of the node address, the sign “/” indicates a separation between hierarchies of tree depths and the number indicates the order among children derived from a common parent. For example, the node “/1” indicates a root node corresponding to a document that is registered by an operation of new document registration. Further, the node “/1/1” indicates the first child of the root node “/1”, and the node “/1/2” indicates the second child of the root node “/1”. Although FIG. 5 shows, for the sake of simplicity, only meta information records belonging to a single tree that are derived from the single root node “/1”, meta information records belonging to a plurality of trees such as trees derived from a root “/1” and a root “/2” can be actually registered in the document management server 10.

Here, the items of the meta information illustrated in FIG. 5 are only examples, and a path name indicative of the storage location of the document content 320 in an ID-added document 320 within the document DB 100, for example, may be additionally registered in the derivation relationship DB 110. If the document DB 100 has a function of retrieving the document content 320 by using the content ID, the content ID may be registered in the meta information record in place of the document storage path name.

Here, FIG. 5 merely expresses the data managed by the derivation relationship DB 110 from a viewpoint of data content, and therefore does not specify any specific expression form or database form. For example, the derivation relationship DB 110 may be configured as a general relational database, or a database in which an XML (eXtensible Markup Language) document that describes meta information other than the management ID is registered while the management ID is used as a key.

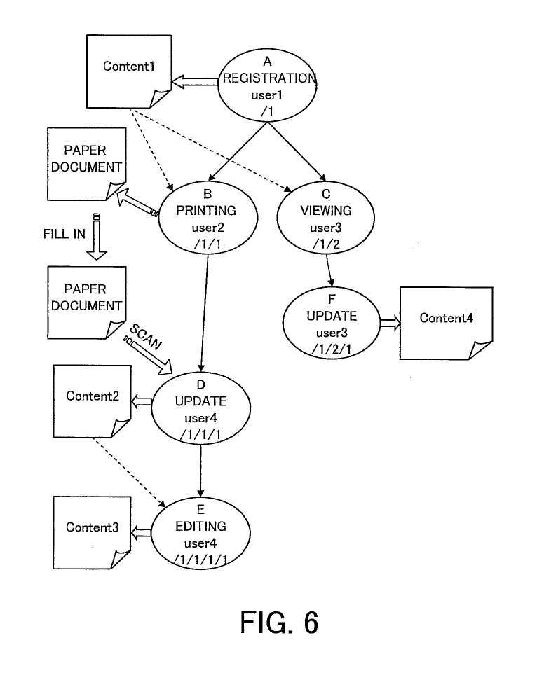

The data content of the derivation relationship DB 110 shown in FIG. 5 forms a tree structure as shown in FIG. 6, in which the management IDs are nodes and the parent-child relationships among the management IDs are edges.

The log of the documents shown in the example of FIGS. 5 and 6 will be described below in time sequence. In this example, there is shown an operation flow in which a certain user registers a form (i.e. a model document) such as an application form in the present system and other users fill in the form and register the filled-in form in the present system.

Specifically, in this example, a “registration” operation with respect to a document (form) is first performed by a client terminal of an operator “user1”. The “registration” operation is an operation for registering in the document management server 10 a document which has not been registered in the document management server 10 (i.e. a document having no management ID, which will also be referred to as an “unregistered document”). In accordance with this operation, an ID-added document “A” including meta information having a management ID “A”, no parent ID, and the operation type “registration” and the document content of the document is sent from the client terminal to the document management server 10. In response, the document management server 10 registers the document content in the ID-added document “A” in the document DB 100 and the meta information of the ID-added document “A” in the derivation relationship DB 110. Here, because of the operation type “registration” and the vacant parent ID in that ID-added document, the document management server 10 determines that the ID-added document which is registered is a root (initiator) of a new tree, rather than a child of any ID-added document already registered in the document management server 10, and accordingly sets a value (“/1” in this case) of the node address. Hereinafter, for the purpose of identification, the document content which is registered in this case will be represented by “Content1.” Subsequently, the user1 distributes the ID-added document which is registered to other users “user2,” “user3,” etc. This distribution of the document can be performed by sending to each user an electronic mail to which the ID-added document is attached.

Thereafter, another user user2 prints the ID-added document “A” by means of the document operation unit 200 of his/her own client terminal. Here, what is actually printed is the document content “Content1” or a document content obtained by editing the document content “Content1.” At this time, the document operation unit 200 embeds, in a paper document obtained as a result of printing, a management ID “B” which is newly assigned thereto. Hereinafter, a paper document having a management ID embedded therein as described above will be referred to as an ID-added paper document. Further, the client terminal generates an ID-added document “B” as a result of the printing operation, and registers the ID-added document “B” in the document management server 10. This ID-added document “B” includes meta information having a management ID “B”, a parent ID “A”, an operator “user2”, and an operation type “printing”. Recognizing, from the value of the parent ID of the received ID-added document, that the document “B” is a child, particularly the first child, of the document “A”, the document management server 10 sets the node address of the document “B” to “/1/1”.

With this operation, the ID-added document “A” that was present in the client terminal 20 of user2 before this operation is replaced with the ID-added document “B” by means of the derivation relationship incorporating unit 204. Specifically, the derivation relationship incorporating unit 204 changes the management ID 312 in the meta information 310 of the earlier ID-added document “A” to the ID “B” that has been newly issued, and also sets the management ID “A” of the earlier document “A” as a value of the parent ID 314 of the new document “B”. Further, the derivation relationship incorporating unit 204 changes a value of the operation type in the log information 316 to “printing”, which is the type of operation performed this time, changes a value of the operation time to the time and date of printing, and further changes a value of the operator to user2. Here, the document content 320 is printed data or a document file representing a document content obtained when the printing is instructed.

As described above, once having been printed, the ID-added document “A” is replaced with the ID-added document “B” obtained after printing. Accordingly, after this replacement, the ID-added document “A” itself is no longer present within the client terminal 20 and the ID-added document “B” is present in place of the ID-added document “A”. Further, the user 2 provides the paper document “B” obtained as a result of printing to another user “user 4”.

Thereafter, still another user “user3” views the ID-added document “A” by using the document operation unit 200 of his or her own client terminal. At this time, the user3 views the document content having the content ID “Content1.” The client terminal generates an ID-added document “C” as a result of viewing and registers the ID-added document “C” in the document management server 10. Here, because the document content is not changed or modified with the “viewing” operation, the content ID of the document content remains “Content1.” Here, when an operation by which the document content is not changed is performed as described above, the client terminal 20 may send to the document management server 10 an ID-added document having no document content. With this viewing operation, the ID-added document “A” which was present within the client terminal 20 of the user3 before the operation is replaced with the ID-added document “C” by the derivation relationship incorporating unit 204. More specifically, with this replacing operation, the derivation relationship incorporating unit 204 changes the management ID 312 of the meta information 310 of the ID-added document “A” to a new management ID “C” and also sets the management ID “A” of the document “A” as a value of the parent ID 314 of the new document “C”. In addition, the derivation relationship incorporating unit 204 changes the value of the operation type in the log information 316 to “viewing”, which is the type of the current operation, changes the value of the operation time and date to those of the viewing operation, and also changes the value of the operator to “user3”. However, the document content 320 remains unchanged, because the current operation is “viewing”.

It is then assumed that the user4 performs writing on the ID-added paper document “B” received from the user2, sets in a scanner the paper document on which writing is performed, and selects an operation of “registering as an approved version” from the operation menu of reading control software on the client terminal 20. As a result, the reading control software controls the scanner to read the paper document and then generates as document content an ID-added document “D” including image data obtained as a result of the reading (hereinafter, this document content will be referred to as “Content2” for the purpose of identification). The ID-added document “D” thus generated is sent to the document management server 10 and also stored in the client terminal 20. The meta information 310 of this ID-added document “D” includes a management ID “D”, a parent ID “B” which is the management ID read from the paper document, and user attribute “user4”. Further, because the operation of “registering as an approved version” performed by the document operation unit 200 is classified as an operation type “update” in the operation types intended for log recording, the meta information of the ID-added document “D” includes a method attribute “update”.

The user4 then edits the ID-added document “D” by using the document operation unit 200. As a result, a new ID-added document “E” including document content “Content3” obtained as a result of editing and a parent ID “D” is registered in the document management server 10. Then, the ID-added document “D” which has been present in the client terminal 20 of the user4 is replaced with this ID-added document “E”.

Then when the user3 performs editing with respect to the ID-added document “C” by the document operation unit 200 and instructs “registration as a update version” on the operation menu, the client terminal generates an ID-added document “F” including a value “F” as a management ID 312, a value “C” as a parent ID 314, and a value “update” as an operation type, replaces the ID-added document “C” with the new ID-added document “F”, and also registers the ID-added document “F” in the document management server 10. With this editing, the document content “Content3” is changed to “Content4”. A record associated with the management ID “F” is then registered in the derivation relationship DB 110 of the document management server 10.

FIGS. 5 and 6 show the documents or operations derived from the document “A” within the derivation relationship DB 110 at this point in time.

Heretofore, the way in which the information of document operations is registered in the present system has been described while the data content of the derivation relationship DB 110 has been used as an example.

Referring again to FIG. 4, the request-processing unit 140 provides a service by using the derivation relationship DB 110, in response to a service request including the management ID transmitted from the client terminal 20. A service to be provided by the request-processing unit 140 may include search of the latest version of a document corresponding to the management ID for which the service is being requested. As another example service, there may be provided the history of the management ID; i.e. the log of the operations experienced by the document from the initiator through the management ID (for example, an information list indicating by who and when and what type of operation is performed). A further example service may be a service of receiving a specified search condition concerning the attribute items registered in the derivation relationship DB 110 and providing a list of ID-added documents that satisfy the search condition. In association with this service, the request-processing unit 140 may receive user's selection of a desired ID-added document from among the list and provide the selected ID-added document. Here, the service of searching for the latest version described above may be considered a service of providing a search result concerning a search condition that “the operation date and time is the latest”. Also, the service of providing information of the initiator document described above may be considered a service of providing a search result concerning a condition that specifies “a document with a node address corresponding to a root”. Also, a further example service may be a service of providing a display screen showing a tree structure indicative of the derivation relationships of the ID-added documents based on the derivation relationship DB 110, receiving user's selection of a desired ID-added document on the display screen, and providing the selected ID-added document.

The service request is issued on the basis of the ID-added document held in the client terminal 20. For example, when a user opens an ID-added document by the document operation unit 200 of the client terminal 20, the document operation unit 200 provides a menu listing services using the derivation relationship and accepts from the menu designation of a service desired by the user. The document operation unit 200 then sends to the request-processing unit 140 of the document management server 10 a service request including the management ID of the ID-added document and a code indicative of a designated service. At this time, a search condition that is input through a user interface screen provided for designating a search condition concerning the attribute items including the user identification information, the operation time and date, and so on, may also be transmitted to the request-processing unit 140 in combination with the service request. Also, in addition to the management ID, the code indicative of a service, and the search condition, the client terminal 20 may transmit to the request-processing unit 140 other information including identification information of a user who provides the instruction, authorization information input by the user, and so on.

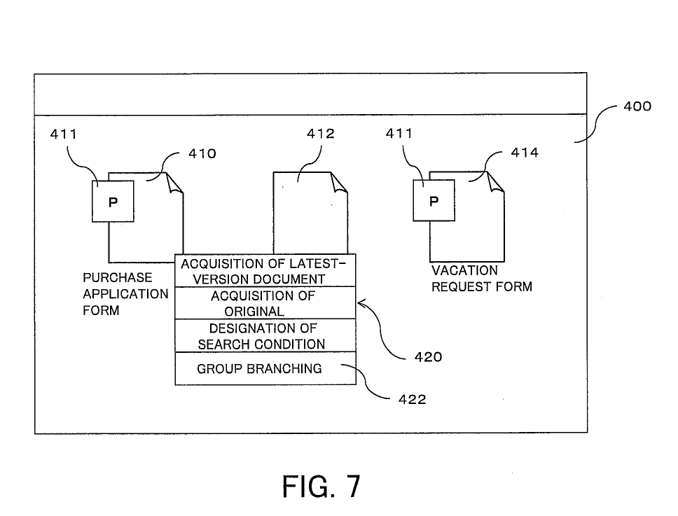

As another example, the service menu as described above may be associated with an object type; i.e. an ID-added document, and registered in the operating system of the client terminal 20. In this case, in response to a predetermined operation, such as right-clicking, which is performed by a user with respect to an icon 410 or 414 of an ID-added document displayed on a file management screen 400 provided by the operating system, the operating system displays on the screen a menu 420 corresponding to the ID-added document, as shown in FIG. 7. In the shown example, an ID-added document indicated by the icon 410 or 414 can be differentiated from a file of another type 412 by a mark 411 indicative of an ID-added document of the present system. When the user selects a desired service from the service items on the menu 420, the client terminal 20 requests the document management server 10 to perform the function designated by the selected service item.

As a further example, it is conceivable to regard designation of a service by a user as one “operation” and assign a new management ID to the “operation.” In this case, an ID-added document including a code of a designated service as an operation type and the management ID of the ID-added document which is used at the time of designation as a parent ID may be generated and sent to the document management server 10 as a service request. In this case, on the basis of the information of the operation type included in the ID-added document thus received, the request-processing unit 140 determines a service to be provided and uses the parent ID similarly included in the ID-added document as a start point when tracing the derivation relationship.

Upon receiving a service request from the client terminal 20, the request-processing unit 140 traverses a tree formed by the derivation relationships of the management IDs and parent IDs registered in the derivation relationship DB 110, starting from the management ID designated during the service request, and then executes a service requested by the user on the basis of the information obtained as a result of the traverse.

Access control with respect to the ID-added documents in the system described above will be described in detail below. In this system, the ID-added documents are classified into groups in a tree structure formed of derivation relationships of the ID-added documents, and with regard to each group, access right information is set. Here, the classification is performed in accordance with the user's instructions. More specifically, in this system, at the time of registering an ID-added document in the document management server 10, there is provided a user interface (UI) for entering an instruction to cause the document to be “branched” from the group to which a parent document belongs. When the user uses the UI to enter a “branching” instruction with regard to the ID-added document which is a subject of registration, the document management server 10 generates a new group and classifies the ID-added document in the new group. When no branching instruction is entered, on the other hand, the document management server 10 classifies the ID-added document in the group to which the parent ID belongs.

In this system, with regard to a group generated as described above, access right information is set. The access right information with regard to a certain group is first set by a user who issued an instruction to generate the group (i.e. an instruction to register a new document or a branching instruction). Here, the user may authorize other users to change the access right information. The document management server 10, upon receiving from a user a request for an ID-added document, refers to the access right information of a group to which the requested ID-added document belongs to determine whether or not the ID-added document should be provided to the user.

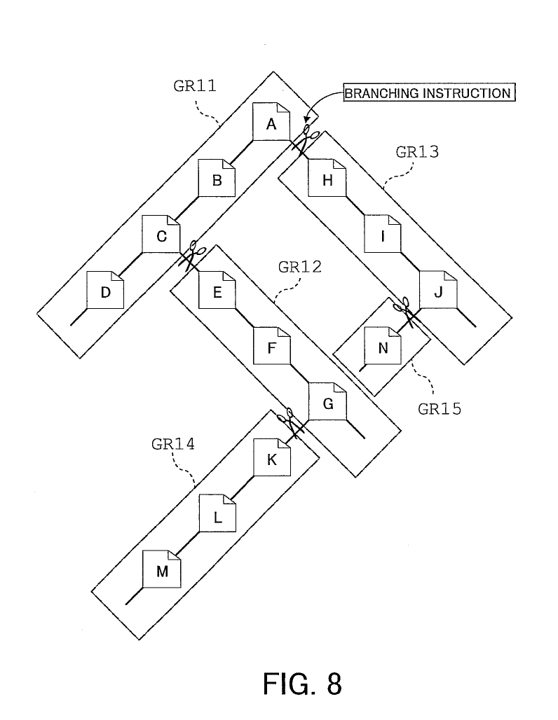

FIG. 8 shows example group branching in which a tree of the derivation relationships including an ID-added document A as a root is shown. In this example, because no branching instruction is issued when registering an ID-added document B generated as a result of an operation performed with respect to the ID-added document A in the document management server 10, the ID-added document B is classified in a group GR11 to which the document A also belongs. Similarly, because no branching instruction is issued when registering an ID-added document C derived from the ID-added document B, the ID-added document C is also classified in the group GR11. Similarly, because no branching instruction is issued when registering an ID-added document “D” derived from the ID-added document C, the ID-added document “D” is also classified in the group GR11. On the other hand, because a user issues a branching instruction when registering an ID-added document E, a new group GR12 is generated and the document E is registered in this group GR12. As described above, a new group is generated in accordance with initial registration of a document in the system (i.e. the document A in the shown example) or a branching instruction (i.e. the documents E, H, K, and N), and a derived document with regard to which no branching instruction is issued is classified in the group to which the parent document belongs.

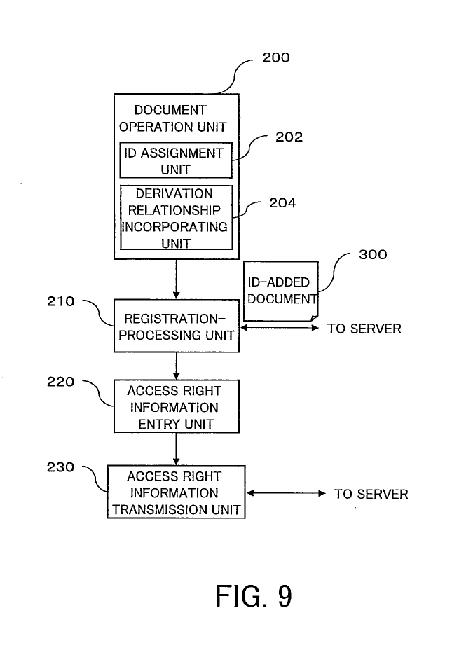

FIG. 9 shows a block diagram showing the function of the client terminal 20 including a function of access right control. In FIG. 9, function blocks which are identical with those in FIG. 2 are denoted by the same numerals.

In the example shown in FIG. 9, a service of allowing a user to cause a document group to branch is provided to the user as one of services concerning the derivation relationships, for example. Specifically, the document operation unit 200 provides a UI which enables a user to instruct a group branching service. In the example UI screen shown in FIG. 7, for example, an item 422 indicating the group branching is included in the menu 420 associated with an ID-added document. When the user issues an instruction of group branching concerning a certain ID-added document X by using such a UI, the document operation unit 200 generates a new ID-added document Y corresponding to a result of the branching operation and registers the new ID-added document Y in the document management server 10. The new ID-added document Y includes a value of the management ID of the ID-added document X as a parent ID 314 (see FIG. 3), and also includes log information 316 having an operation type “branch” and the document content 320 which is the same content as that of the ID-added document X.

Although in the above example an instruction of group branching is implemented as one operation with respect to an ID-added document, a method of instructing group branching is not limited to this example. For example, when registering a new ID-added document generated as a result of an operation which is performed with respect to an existing ID-added document in the document management server 10, a user may be allowed to designate whether or not the new ID-added document is to be branched from the parent ID-added document. Alternatively, when a user edits an ID-added document by the document operation unit 200 and completes the editing, the document operation unit 200 may provide a UI screen inquiring whether or not to designate group branching and accept the user's selection. In this case, the log information 316 of an ID-added document to be generated includes, in addition to the operation type, a selection result as to whether or not group branching is designated.

When a user issues an instruction of “group branching” as described above, the document management server 10 generates a new group and also sends to the client terminal 20 a notification which requests setting of access right information with respect to the new group. In this case, in the client terminal 20, an access right information entry unit 220 provides to the user a UI screen for access right setting. This UI screen may include entry boxes for access rights (e.g. Read right, Write right, and so on) concerning each user or each user group registered in the document management server 10. Various types of such UIs intended for access right setting have been conventionally used, and these conventional UIs may be used in this system. In this regard, it is possible to previously set a default value concerning access right information and allow a user to change the default value. When the user inputs access right information in the access right entry unit 220, an access right information transmission unit 230 transmits the input information to the document management server 10.

The UI screen for access right setting may be provided as a web page by the document management server 10 to the client terminal 20. In this case, the functions of the access right information entry unit 220 and the access right information transmission unit 230 can be achieved by a web browser installed in the client terminal 20.

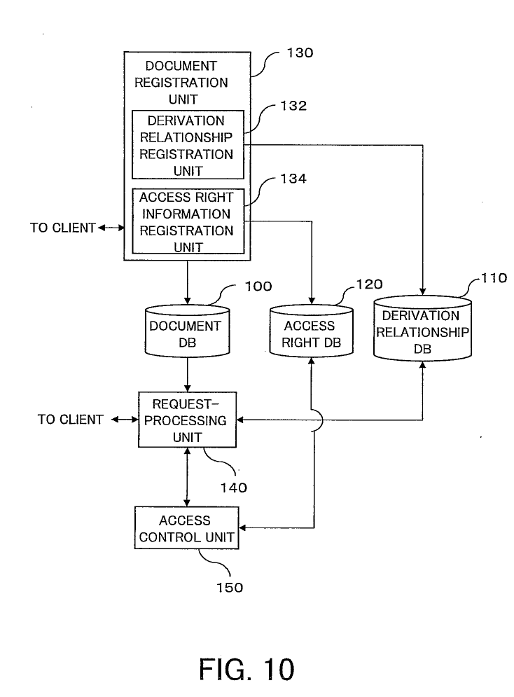

With reference to FIG. 10, a structure of the document management server 10 having an access control function will be described. In FIG. 10, function blocks which are identical with those in FIG. 4 are designated by the same numerals and will not be described in detail.

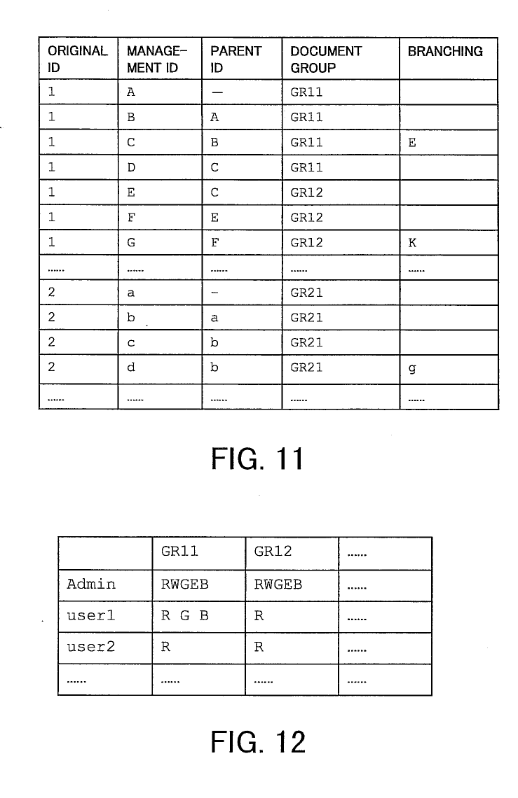

In this example, the derivation relationship registration unit 132 of the document management server 10 registers in the derivation relationship DB 110, as one item of a meta information record of an ID-added document, an ID of a document group to which the ID-added document belongs (hereinafter will be referred to a group ID). Example data content of the derivation relationship DB 110 in this example is illustrated in FIG. 11, in which the items such as the operation type and the operation time and date are omitted. The example data content corresponds to the branch structure of the derivation relationships shown in FIG. 8. For example, the example shown in FIG. 11 shows that, among the ID-added documents corresponding to the original ID “1”, the documents A to D belong to the document group GR11 and the documents E to G belong to the document group GR12. Further, in this example, the meta information record of an ID-added document includes an item “branching” which indicates an ID-added document which is branched from the target ID-added document (hereinafter such a document obtained by branching will be referred to as a “branching destination”). For example, the meta information of the ID-added document C includes a value of “E” as a branching destination document. Here, there are cases where multiple branching destination documents are registered with regard to one document.

Further, the document registration unit 130 includes an access right information registration unit 134. The access right information registration unit 134 receives the access right information transmitted by the access right information transmission unit 230 of the client terminal 20 and registers the received access right information in an access right DB 120. FIG. 12 shows example data content registered in the access right DB 120. As shown in this example, in this access right DB 120, a list of access rights which each user or each user group has with respect to each document group GR11, GR12, and so on is registered in association with each user ID or each user group ID (such as “Admin”, “user1” and so on in the illustrated example). In this example, “R” indicates read right which authorizes viewing of an ID-added document within the target document group, and “W” indicates write right which authorizes editing of the document content of an ID-added document within the target document group. Further, “G” indicates acquisition right which authorizes acquisition of an ID-added document within the target document group, and “E” indicates change right to change the access right information concerning an ID-added document within the target document group. Finally, “B” indicates branching right which authorizes a user to cause the target document group to branch into another document group at a certain ID-added document in that target document group. For example, the “user1” has rights for read, acquisition, and branching with respect to the documents within the group GR 11. Here, the five types of rights described above are only examples.

Referring back to FIG. 10, the request-processing unit 140, when providing an ID-added document in response to a service request from a user, refers to an access control unit 150 to inquire about the user's access right to the ID-added document to be provided. Then access control unit 150 refers to the access right DB 120 to obtain the user's access right to a document group to which the target ID-added document belongs and provides information concerning the access right thus obtained to the request-processing unit 140. The request-processing unit 140, based on the access right information that is received, determines whether or not to provide the ID-added document to the user and, if the ID-added document is to be provided, determines rights the user is authorized to have.

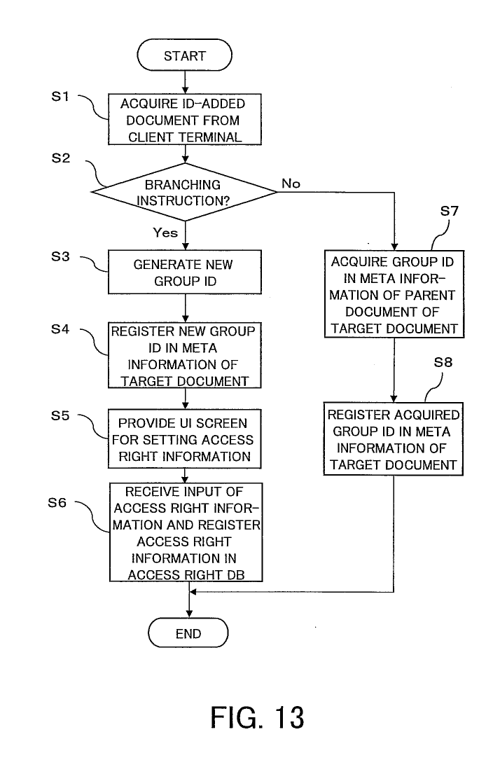

Referring further to FIG. 13, there will be described an example processing procedure performed by the document management server 10 when a new ID-added document is provided from the client terminal 20. In this procedure, the document management server 10, when acquiring an ID-added document from the client terminal 20 (S1), determines whether or not a user has issued an instruction of group branching, based on the information concerning the operation type or the branch request included in the log information 316 of that ID-added document (S2). When it is determined that a branching instruction has been issued, the document registration unit 130 generates a unique group ID for a new document group (S3) and sets the group ID in the item of group ID of meta information of the ID-added document in the derivation relationship DB 110 (S4). Further, the document management server 10 sends to the client terminal 20 a request for inputting access right information with regard to the new document group (S5). In providing this request, the document management server 10 may provide a web page for use in entry of the access right information to the client terminal 20. Then, when the access right information is input by the client terminal 20 in response to the request, the access right registration unit 134 registers the access right information which is input in the access right DB 120 (S6).

On the other hand, if in step S2 it is determined that no branching instruction has been issued, the document registration unit 130 acquires from the derivation relationship DB 110 a group ID of a document group to which a parent document of the target ID-added document belongs (S7). In this step, a value of a group ID in the meta information record including the parent ID 314 of the target ID-added document as a management ID can be simply obtained from the derivation relationship DB 110. The document registration unit 130 then registers the group ID thus obtained as a group ID of the target ID-added document in the derivation relationship DB 110 (S8).

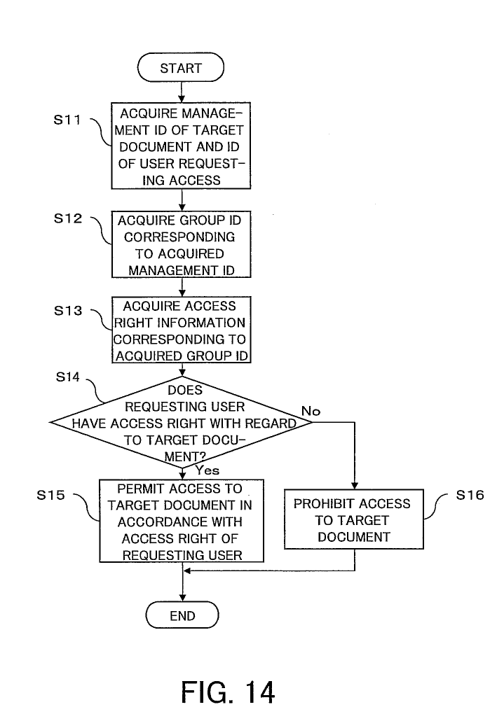

Referring now to FIG. 14, there will be described an example processing procedure performed by the document management server 10 when receiving an operation request with respect to an ID-added document. The procedure shown in FIG. 14 is executed in a case where a search service is performed and a list of a search result is provided to a user, who then designates a desired ID-added document from the list and instructs an operation. Alternatively, the procedure shown in FIG. 14 may also be executed in a case where a display screen showing a tree-structure representing the derivation relationships of ID-added documents is provided and the user's selection of a desired ID-added document is accepted on the display screen.

With this procedure, the request-processing unit 140 first acquires a management ID of an ID-added document which is an operation subject and further acquires a user ID of a user who requested the operation (S11). Here, the management ID of the target document can be specified by the search result or a result of user's selection in display of the tree structure. Also, the user ID can be acquired from the client terminal 20. The request-processing unit 140 supplies the management ID and the user ID acquired in step S11 to the access control unit 150. The access control unit 150 acquires a group ID corresponding to the received management ID from the derivation relationship DB 110 (S12), and then obtains from the access right DB 120 access right information corresponding to a combination of the group ID and the user ID described above (S13). The access control unit 150 then determines, based on the access right information which is obtained, whether or not the user has access right with respect to the target ID-added document (S14). If the user has access right, in accordance with the access right, the access control unit 150 authorizes the user to access the ID-added document (S15). When the access right information corresponding to a combination of the group ID and the user ID acquired in step S13 includes only read right (R), the access control unit 150 instructs the request-processing unit 140 to provide the ID-added document to a user in such a state that the user can only view the document (i.e. editing of the document is not allowed). The request-processing unit 140, when receiving such an instruction, sets the target ID-added document in a state where viewing of the ID-added document is allowed and then transmits the target ID-added document to the client terminal 20 which issued the request. The document operation unit 200 of the client terminal 20 then restricts the user's operation in accordance with the setting of the ID-added document which is received. For example, with regard to the ID-added document which is set in a state where only viewing is allowed, the document operation unit 200 does not accept an instruction of editing.

Further, if it is determined in step S14 that the user does not have access right with respect to the target document, the access control unit 150 does not authorize the user to access the document (S16). In this case, the request-processing unit 140 sends to the client terminal 20 a message indicating that access to that document is not allowed.

In an example modification of the above procedure, information concerning the operation type instructed by the user may be additionally obtained from the client terminal 20 in step S11, so that the operation type can be taken into consideration at the time of determination in step S14. For example, when a user instructs an editing operation with respect to an ID-added document, in the determination made in step S14, the document management server 10 may check whether or not the user has write right (W) with respect to a document group to which the ID-added document belongs. If it is determined that the user does not have write right (W), the process may proceed to step 16 for prohibiting access to the document, so that the document is not to be provided to the user.

In another example, when an ID-added document is acquired from the client terminal, the document management server 10 may determine whether or not to accept the ID-added document based on the access right DB 120. More specifically, although in the structure of the present system, when an operation is performed with respect to an ID-added document on the client terminal 20, a new ID-added document which reflects the operation result is generated and registered in the document management server 10, if the user who instructed the operation does not have right to perform the operation, it is conceivable that the ID-added document generated as a result of the operation should not be regarded an appropriate document and therefore should not be registered in the document management server 10.

Accordingly, in this example, when receiving an ID-added document which reflects an operation result transmitted from the client terminal 20, the document management server 10 determines whether or not the operation was instructed by a user having authorized right. For this determination, the parent ID 314 and information concerning the operator and the operation type in the ID-added document received from the client terminal 20 can be used. Here, the value of the parent ID 314 is the same as the value of the management ID of the ID-added document with regard to which the operation was performed (i.e. an operation subject). The document management server 10 searches the derivation relationship DB 110 for a meta information record including this parent value as a management ID to thereby specify an ID of a document group to which the operation subject belongs. The document management server 10 further searches the access right DB 120 for access right information corresponding to the combination of the group ID and the above-described operator. Then, based on the access right information which is retrieved, the document management server 10 determines whether or not the operation indicated by the operation type included in the received ID-added document is allowable. If it is determined that the operation is allowable, the document management server 10 registers the ID-added document in the document DB 100 and the derivation relationship DB 110. On the other hand, if it is determined that the operation is not allowable, the document management server 10 does not register the ID-added document in the document DB 100 or the like and transmits to the client terminal an error code indicative of unregisterability. The client terminal 20, upon receiving this error code, discards or invalidates the ID-added document.

For example, when a user performs an operation of group branching with respect to an ID-added document, the client terminal 20 generates, as a child of the ID-added document, a new ID-added document including a value of the operation type “branching”, and transmits the new ID-added document to the document management server 10. The document management server 10 then obtains access right information of a document group to which a parent document of the received ID-added document belongs, and determines, based on the access right information, whether or not the user has right of “branching” with regard to the group. If the user has right of “branching”, the document management server 10 executes the processing in steps S3 to S6 in FIG. 13.

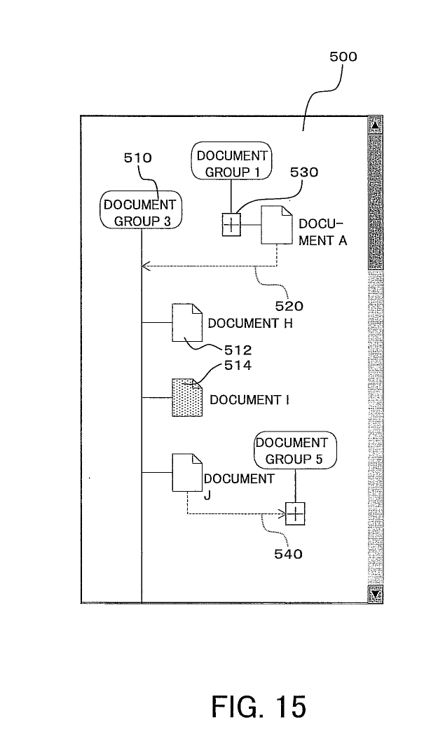

Referring now to FIG. 15, an example of a derivation relationship display screen 500 provided to the user will be described. As shown, the derivation relationship display screen 500 displays icons 512, 514, and so on representing ID-added documents which are classified in corresponding document groups. Each group is indicated by a mark 510 representing a corresponding group, and icons of documents that belong to the group are arranged in the order of derivation along the line extending from the corresponding mark 510 in the downward direction. Dotted lines with arrows 520 and 540 indicate branching of a group. Specifically, the dotted line 520 indicates that a document group 1 branches into a document group 3 at a document A and the dotted line 540 indicates that the document group 3 branches into a document group 5 at a document J. A mark “+” indicates that display of document icons within that group is omitted, and when a user clicks on the mark, the document icons which are not displayed will appear.

In this example, only the document groups with regard to which the user who requested display of derivation relationships has access right are displayed based on the access right DB 120. The example in FIG. 15 shows a case where a user having access right with regard to the document groups 1, 3, and 5 selects an ID-added document I stored in his/her own client terminal 20 and requests display of derivation relationships concerning this document. Upon receiving this request, the document management server 10 traces the derivation relationships from the document I to obtain a root of a tree to which the document I belongs, and then traces the tree back from the root towards the descendents to specify the documents that belong to the tree. The document management server 10 then classifies the documents into document groups and determines, based on the access right DB 120, document groups with regard to which the user who issued the request has access right. The document management server 10 further generates information of the display screen 500 indicating the document groups with regard to which the user has access right and provides the information to the client terminal 20. Here, the information of the display screen 500 may be provided simply as a web page, for example.

The user can select an icon of an ID-added document on this derivation relationship display screen 500 and instruct an operation concerning the selected document. The operation concerning a document includes a download operation of the document. Also, an instruction of changing the access right with regard to a document group may be accepted on this screen. For example, when the user selects a mark 510 of a certain document group to invoke an operation menu and then selects change of access right on the menu, the document management server 10 acquires from the access right DB 120 information as to whether or not the user has authorization to change the access right with regard to the group, and if the user has such authorization, provides to the client terminal 20 a screen for setting the access right information.

Although in the example shown in FIG. 15, (1) there are displayed all the document groups in a tree of the derivation relationship with regard to which a user who requested display of documents has access right, this is only one example. Alternatively, (2) only a document group to which the document (the document I in the example of FIG. 15) that was used by the user at the time of request belongs may be displayed. In addition, (3) it is also possible to display all the documents belonging to a tree to which the document used by the user at the time of request belongs, irrespective of the presence of the user's access right and, when the user instructs an operation with respect to a certain document among the displayed documents, to check the user's access right to determine whether or not the instructed operation is to be performed. In the method (3) described above, with regard to a document group with regard to which the user has no access right, there may be displayed contact information (e.g. a name or e-mail address) of a manager of that group (e.g. a user who performed a branching operation which triggers generation of that group). In this case, the user can make contact with the manager by using the contact information to have the manager set the access right. Further, the display methods (1), (2), and (3) described above may be selectable.

Although in the example described above the management ID is issued by each client terminal 20, the document management server 10 may instead issue the management ID. In this case, the client terminal 20, when performing an operation with respect to an ID-added document, generates document data which include the management ID in the ID-added document prior to the operation as the parent ID 34, the log information 316 concerning the operation, and the document content 320 obtained after the operation, with no management ID 312, and sends the document data to the document management server 10. The document management server 10 then assigns a new management ID to the document data which is received and registers the management ID and the information included in the document data in the document DB 100 and the derivation relationship DB 110. The document management server 10 further sets the assigned management ID in the document data to generate an ID-added document, and returns this ID-added document to the client terminal 20. The client terminal 20 then replaces the ID-added document prior to the operation with the ID-added document which is received. As such, the processing of the above example can be executed similarly with the structure in which the management ID is assigned by the document management server 10.

Further, although in the example described above, the ID-added document 300 including the management ID 312, the parent ID 314, the log information 316, and the document content 329 is stored in the client terminal 20, there may be employed a configuration where only the management ID is stored in the client terminal 20 while other information is stored in the document management server 10. In this case, when the client terminal 20 is to perform an operation with regard to a document, the management ID corresponding to the document is sent to the document management server 10, which then provides the corresponding document to the client terminal 20. In another example, there may be employed a configuration that the ID-added document 300 stored in the client terminal 20 includes only the management ID 312 and the document content 320, and does not include the parent ID 314 and the log information 316. In this case, the document management server may store the parent ID 314 and the log information 316 in association with the corresponding management ID 312.

Here, when the document management server 10 assigns the management ID, the document management server 10 generates a management ID corresponding to the acquisition operation and provides to the client terminal 20 the management ID in association with the document. The document management server 10 also records in the derivation relationship DB 110 the log information (the operation time and date, the operator, and so on) concerning the acquisition operation, the earlier management ID (i.e. the parent ID), and the assigned management ID. The client terminal 20 replaces the management ID sent to the document management server 10 with the management ID which is received, and opens the received document. The user then performs an operation such as viewing and editing with respect to the opened document. When the operation with respect to the document is completed, the client terminal 20 sends the document obtained by the operation, along with the management ID and the log information concerning the operation, to the document management server 10. The document management server 10 assigns a new management ID to the document which is received and registers the document with the new management ID in the derivation relationship DB 110, and further registers the management ID which is received from the client terminal 20 in the derivation relationship DB 110 as the parent ID. In addition, the document management server 10 registers the log information and the document after the operation which is received in the derivation relationship DB 110 and the document DB 100, respectively. The document management server 10 then returns to the client terminal 20 the management ID newly assigned. The client terminal 20 replaces the earlier management ID with the received management ID. With the above processing, the derivation relationships among the operations are to be accumulated in the document management server 10.

Meanwhile, in the structure in which the management ID is assigned by the client terminal 20, the document management server 10 can simply return to the client a document corresponding to the management ID received from the client terminal 20. The client terminal 20 opens the document which is received, so that the user can perform an operation on the document. After completion of the operation, the client terminal 20 assigns a new management ID to the document obtained as a result of the operation and sends to the document management server 10 the ID-added document described above including this new management ID and the corresponding information. Then, the client terminal 20 stores only the management ID in the ID-added document and deletes other information.

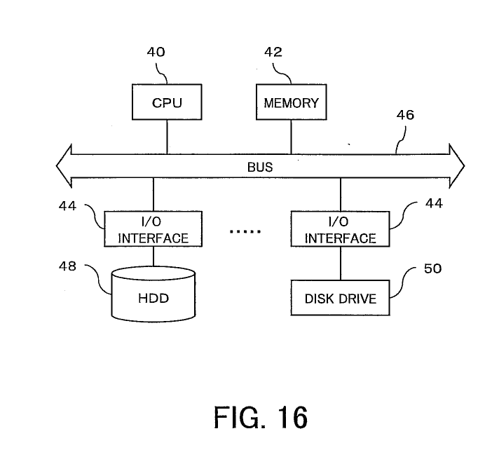

The document management server 10 in the illustrated system described above is typically implemented by executing a program that describes the function or processing contents of each unit of the document management server described above, by means of a general-purpose computer. As shown in FIG. 16, the computer includes, as hardware, a circuit structure in which a CPU (central processing unit) 40, a memory (primary memory) 42, various I/O (input/output) interfaces 44, and so on are interconnected via a bus 46, for example. Further, a hard disk drive 48 and a disk drive 50 for reading portable non-volatile recording media of various standards such as CDs and DVDs and flash memories are connected, via the I/O interfaces 44, for example, to the bus 46. Such a drive 48 or 50 functions as an external storage device for the memory. The program that describes the processing contents of the exemplary embodiment is stored in a fixed storage device such as the hard disk drive 48 via a recording medium such as a CD or DVD or via the network, and then installed in the computer. When the program stored in the fixed storage device is read into the memory and executed by the CPU, the processing of the exemplary embodiment is implemented. Similarly, the client terminal 20 can be implemented by causing a general-purpose computer to execute a program that describes the document-processing program described above.

The foregoing description of the exemplary embodiments of the present invention has been provided for the purposes of the illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

What is claimed is:

1. A document management apparatus comprising:
a derivation relationship registration unit that, when receiving a second document obtained as a result of an operation performed with respect to a first document, registers in a storage device a derivation relationship indicating that a parent of the second document is the first document;
a group information registration unit that, when receiving a branching instruction in association with the second document, generates a new document group and registers in the storage device information indicating that the second document belongs to the new document group and that, when receiving no branching instruction in association with the second document, registers in the storage device information indicating that the second document and the first document belong to the same document group;
an access right registration unit that receives input of access right information with respect to a document group and registers the thus-input access right information in the storage device in association with the document group; and
a control unit that, when receiving a request for an operation with respect to a document from a user, acquires access right information corresponding a document group to which the document belongs from the storage device and, based on the access right information that is acquired, controls whether or not to allow the user to perform the operation with respect to the document.

2. The document management apparatus according to claim 1, wherein
when receiving a branching instruction in association with the second document, the access right registration unit transmits a request for inputting access right information concerning the new document group to an information processing apparatus which has transmitted the branching instruction, and registers the access right information input by the information processing apparatus in response to the request in the storage device in association with the new document group.

3. The document management apparatus according to claim 1, further comprising:
a display information transmission unit that, when receiving a user's instruction to display a derivation relationship from an information processing apparatus, generates display information representing a tree structure of documents formed by derivation relationships stored in the storage device and transmits the display information to the information processing apparatus,
wherein the display information transmission unit specifies a document group with regard to which the user has access right based on the access right information registered in the storage device, and generates display information indicating documents belonging to the document group with regard to which the user has access right among the documents in the tree structure.

4. A computer-readable medium storing a program causing a computer to execute a process for controlling use of a document, the process comprising:
when receiving a second document obtained as a result of an operation performed with respect to a first document, registering in a storage device a derivation relationship indicating that a parent of the second document is the first document;
when receiving a branching instruction in association with the second document, generating a new document group and registering in the storage device information indicating that the second document belongs to the new document group, and when receiving no branching instruction in association with the second document, registering in the storage device information indicating that the second document and the first document belong to the same document group;
receiving input of access right information with respect to a document group and registering the thus-input access right information in the storage device in association with the document group; and
when receiving a request for an operation with respect to a document from a user, acquiring access right information corresponding to a document group to which the document belongs from the storage device and, based on the access right information that is acquired, controlling whether or not to allow the user to perform the operation with respect to the document.

5. The computer-readable medium according to claim 4, the process further comprising:
when receiving a branching instruction in association with the second document, transmitting a request for inputting access right information concerning the new document group to an information processing apparatus which has transmitted the branching instruction, and registering the access right information input by the information processing apparatus in response to the request in the storage device in association with the new document group.

6. The computer-readable medium according to claim 4, the process further comprising:
when receiving from an information processing apparatus a user's instruction to display a derivation relationship, generating display information representing a tree structure of documents formed by derivation relationships stored in the storage device and transmitting the display information to the information processing apparatus, and
specifying a document group with regard to which the user has access right based on the access right information registered in the storage device and generating display information indicating documents belonging to the document group with regard to which the user has access right among the documents in the tree structure.

7. A method of managing a document comprising:
when receiving a second document obtained as a result of an operation performed with respect to a first document, registering in a storage device a derivation relationship indicating that a parent of the second document is the first document;
when receiving a branching instruction in association with the second document, generating a new document group and registering in the storage device information indicating that the second document belongs to the new document group, and when receiving no branching instruction in association with the second document, registering in the storage device information indicating that the second document and the first document belong to the same document group;
receiving input of access right information with respect to a document group and registering the thus-input access right information in the storage device in association with the document group; and
when receiving from a user a request for an operation with respect to a document, acquiring from the storage device access right information corresponding a document group to which the document belongs and, based on the access right information that is acquired, controlling whether or not to allow the user to perform the operation with respect to the document.

8. The method according to claim 7, further comprising:
when receiving a branching instruction in association with the second document, transmitting a request for inputting access right information concerning the new document group to an information processing apparatus which has transmitted the branching instruction, and registering the access right information input by the information processing apparatus in response to the request in the storage device in association with the new document group.

9. The method according to claim 7, further comprising:
when receiving from an information processing apparatus a user's instruction to display a derivation relationship, generating display information representing a tree structure of documents formed by derivation relationships stored in the storage device and transmitting the display information to the information processing apparatus, and
specifying a document group with regard to which the user has access right based on the access right information registered in the storage device and generating display information indicating documents belonging to the document group with regard to which the user has access right among the documents in the tree structure.

10. A document management system comprising a first information apparatus, a second information processing apparatus, and a document management apparatus,
the first information apparatus including:
an instruction reception unit that receives an execution instruction to execute an operation with respect to a first document and an instruction concerning whether or not to allow a second document that is obtained as a result of the operation to be branched from a document group to which the first document belongs;
an operation execution unit that executes the operation with respect to the first document in accordance with the execution instruction;
an instruction transmission unit that, when an operation is executed with respect to the first document by the operation execution unit, transmits the second document that is obtained as a result of the operation to the document management apparatus, and when an instruction to cause the second document to be branched from the document group to which the first document belongs is received by the instruction reception unit, transmits a branching instruction to the document management apparatus in association with the second document;
an access right entry unit that receives input of access right information corresponding to a document group; and
an access right transmission unit that transmits to the document management apparatus the access right information that is input to the access right entry unit,
the second information processing apparatus including:
a designation reception unit that receives user's designation of a document that is an operation target; and
a request transmission unit that, based on the designation received by the designation reception unit, transmits an output request including information that specifies the document that is an operation target to the document management apparatus in association with information that specifies the user, and
the document management apparatus including:
a derivation relationship registration unit that, when receiving a second document obtained as a result of an operation performed with respect to a first document, registers in a storage device a derivation relationship indicating that a parent of the second document is the first document;
a group information registration unit that, when receiving a branching instruction in association with the second document, generates a new document group and registers in the storage device information indicating that the second document belongs to the new document group and that, when receiving no branching instruction in association with the second document, registers in the storage device information indicating that the second document and the first document belong to the same document group;
an access right registration unit that receives input of access right information with respect to a document group and registers the access right information that is input in the storage device in association with the document group; and
a control unit that, when receiving a request for an operation with respect to a document from a user, acquires access right information corresponding a document group to which the document belongs from the storage device and, based on the access right information that is acquired, controls whether or not to allow the user to perform the operation with respect to the document.
